(19) United States
(12) Patent Application Publication
(10) Pub. No.: US 2006/0144966 A1
(43) Pub. Date: Jul. 6, 2006

(54) Atomising nozzle

(76) Inventors: Helmut Schwegler, Pleidelsheim (DE); Ian Faye, Stuttgart (DE); Markus Gesk, Karlsbad (DE); Frank Miller, Ilsfeld (DE); Hartmut Albrodt, Tamm (DE); Franz Thoemmes, Bietigheim-Bissingen (DE)

Correspondence Address: KENYON & KENYON LLP, ONE BROADWAY, NEW YORK, NY, 10004, US

(21) Appl. No.: 10/531,408

(22) PCT Filed: Aug. 12, 2003
(86) PCT No.: PCT/DE03/02709

§ 371 Date: Feb. 26, 2006

(30) Foreign Application Priority Data
Oct. 14, 2002 (DE) 102 47 764.7

(51) Int. Cl. B05B 1/14

(52) U.S. Cl. 239/554

(57) ABSTRACT

An atomizer nozzle for fuels, particularly for charging a chemical reformer for obtaining hydrogen, features a nozzle body, having spray-discharge orifices discharging into a metering space, and at least one metering aperture, The spray-discharge orifices are situated with a radial directional component with respect to a center axis of the nozzle body at elevation levels, each elevation level having at least one spray-discharge orifice. At least one nozzle body insert, having at least one flow-through opening, is situated in the nozzle body in front of the first elevation step in the direction of fuel flow and/or between the elevation steps.

### FIELD OF THE INVENTION

The present invention is based on an atomization system.

### BACKGROUND INFORMATION

In fuel cell-supported transportation systems, so-called chemical reformers are used for obtaining the required hydrogen from hydrocarbon-containing fuels.

All the substances needed by the reformer for the course of reaction such as air, water and fuel are ideally supplied to the reformer in the gaseous state. However, since the fuels, such as methanol or gasoline, and water, are preferably stored onboard the transportation system in liquid form, they must be heated so as to be vaporized shortly before being fed into the reformer. This requires a pre-evaporator capable of providing adequate quantities of gaseous fuel and water vapor, the waste heat of the reformer normally being used for vaporization.

Since the hydrogen is normally consumed immediately, chemical reformers must be capable of adjusting the production of hydrogen to the demand without delay, e.g. in response to load changes or during start phases. Especially in the cold start phase, additional measures must be taken, since the reformer does not provide any waste heat. Conventional evaporators are not capable of generating adequate quantities of gaseous reactants without delay.

So-called catalytic burners provide the temperature required for the chemical reaction, in which the fuel among other things is reformed to hydrogen, for example. Catalytic burners are components featuring surfaces coated with a catalyst. In these catalytic burners, the fuel/air mixture is converted into heat and exhaust gases, the generated heat being conducted to the suitable components such as the chemical reformer or an evaporator via, for example, the lateral surfaces and/or via the warm exhaust-gas stream.

The conversion of fuel into heat is highly dependent on the size of the fuel droplets striking the catalytic layer. The smaller the size of the droplets and the more uniformly the catalytic layer is charged with the fuel droplets, the more completely the fuel is converted into heat and the higher is the efficiency. In this way, the fuel is also converted more quickly, reducing pollutant emissions. Fuel droplets that are too large in size result in a coating of the catalytic layer and hence in a slow conversion rate. This leads to poor efficiency, especially in the cold start phase.

It is therefore practical to introduce the fuel into the reformer/catalytic burner in a finely divided form with the aid of an atomization device, in which case, provided that there is a sufficient supply of heat, the vaporization process is improved by the large surface area of the finely divided fuel.

Devices for metering fuels into reformers are known, for example, from the U.S. Pat. No. 3,971,847. According to this document, metering devices located relatively far away from the reformer are used to meter the fuel via long supply lines and a simple nozzle into a temperature-adjusted substance stream. In the process, the fuel first strikes baffle plates positioned downstream of the nozzle outlet orifice, which are designed to swirl and distribute the fuel, before arriving via a relatively long vaporization section, necessary for the vaporization process, at the reaction area of the reformer. The long supply line allows the metering device to be insulated from thermal influences of the reformer.

A particularly disadvantageous feature in the devices known from the above-mentioned document is the fact that, due to the simple construction of the nozzle and the positioning of the baffle plates, a targeted metering of fuel, for example into areas of the reformer that have a large supply of heat, is possible only to an insufficient degree. This leads to the need for a relatively large space due to the necessity of a long and voluminous vaporization section.

Furthermore, problems arise in cold start operation, since long and voluminous vaporization sections are slow to heat up and also give off a relatively large amount of heat unused. On the basis of the arrangements of nozzle and baffle plates described in U.S. Pat. No. 3,971,847 it is in particular impossible to wet the interior surface of a hollow cylinder uniformly with fuel, in so doing exclude certain surfaces of the hollow cylinder from being wetted with fuel, or adjust the quantity of the metered fuel to the distribution of the supply of heat in the metering space. Also the shape of the fuel cloud resulting from the metering process can be influenced only to an insufficient degree.

### SUMMARY OF THE INVENTION

By contrast, the atomizer nozzle according to the present invention has the advantage that, by virtue of a suitable design and arrangement, the fuel may be introduced in conformance with the supply of heat prevailing in the metering space. This optimizes the process of vaporizing the fuel and allows it to take place in a small, rapidly heated space. In addition, it is possible to improve the operating performance, since for example measuring paths or measuring surfaces, sensors for instance, may be largely excluded from being charged with fuel. The geometry of the discharged fuel or fuel cloud is singularly adaptable to the circumstances prevailing in the metering space and to the conditions given thereby.

In a first advantageous refinement, the nozzle body of the atomizer nozzle is formed as a hollow cylinder. This allows for a very simple, precise and therefore inexpensive manufacture of the atomizer nozzle. Moreover, the atomizer nozzle may thus be manufactured for example from standardized semi-finished parts, e.g. from standardized metal tubes.

In a further advantageous refinement, a gas supply port for supplying a gas, for example air or residual gases from a fuel cell or reforming process, is situated between the spray-discharge orifices of the first elevation step and the metering aperture. This allows for the mixture formation to be advantageously influenced.

Moreover, the atomizer nozzle may refined in that at least one additional spray-discharge orifice is situated downstream of the last spray-discharge orifice of an elevation step in the direction of the fuel flow, which additional spray-discharge orifice has an axial component with respect to the center axis of the nozzle body. This allows for the atomization of fuel to be adapted even better to the conditions prevailing in the metering space.

Due to the geometric shape of the nozzle body inserts, the flow behavior of the fuel in the nozzle body may be influenced advantageously, nozzle body inserts having rectangular, concave or convex cross sections being particularly advantageous and simple to manufacture and to install. Moreover, the shape of the flow-through opening may influence the flow behavior or the pressure conditions in the nozzle body. In this regard, flow-through openings having a trapezoidal, a rectangular or a combination of a rectangular and a trapezoidal cross section are particularly advantageous, especially since they can be manufactured simply, precisely and thus inexpensively. It is furthermore advantageous to implement the flow-through opening in multiple uniform cross sections of varying size, for example as a stepped bore hole.

If the nozzle body includes sections of reduced wall thickness, then particularly the thermal conductivity towards the metering point will be reduced. A metering device situated in that location will thereby be protected from excessive heating. The sections of reduced wall thickness can also influence the spray-off geometry if these sections are situated in the area of the spray-discharge openings.

### BRIEF DESCRIPTION OF THE DRAWINGS

FIG. 1 shows a schematic sectional view of a first exemplary embodiment of an atomizer nozzle according to the present invention.

FIG. 2A shows a schematic view of a first specific embodiment of a nozzle body insert situated in the atomizer nozzle of the present invention.

FIG. 2B shows a schematic view of a second specific embodiment of a nozzle body insert situated in the atomizer nozzle of the present invention.

FIG. 2C shows a schematic view of a third specific embodiment of a nozzle body insert situated in the atomizer nozzle of the present invention.

FIG. 2D shows a schematic view of a fourth specific embodiment of a nozzle body insert situated in the atomizer nozzle of the present invention.

FIG. 2E shows a schematic view of a fifth specific embodiment of a nozzle body insert situated in the atomizer nozzle of the present invention.

FIG. 2F shows a schematic view of a sixth specific embodiment of a nozzle body insert situated in the atomizer nozzle of the present invention.

FIG. 3 shows a schematic partial sectional view of an exemplary embodiment of the atomizer nozzle according to the present invention in the region of an elevation step.

### DETAILED DESCRIPTION

In the following, exemplary embodiments of the invention are described by way of example.

The exemplary embodiments described below of atomizer nozzles designed according to the present invention allow for simple metering and atomization in a hot atmosphere, while providing a robust construction, application in different spatial constellations and the use of standard low-pressure fuel injectors.

Identical parts are provided with the same reference numerals in all of the figures. The arrows represent the respective fuel and gas flows.

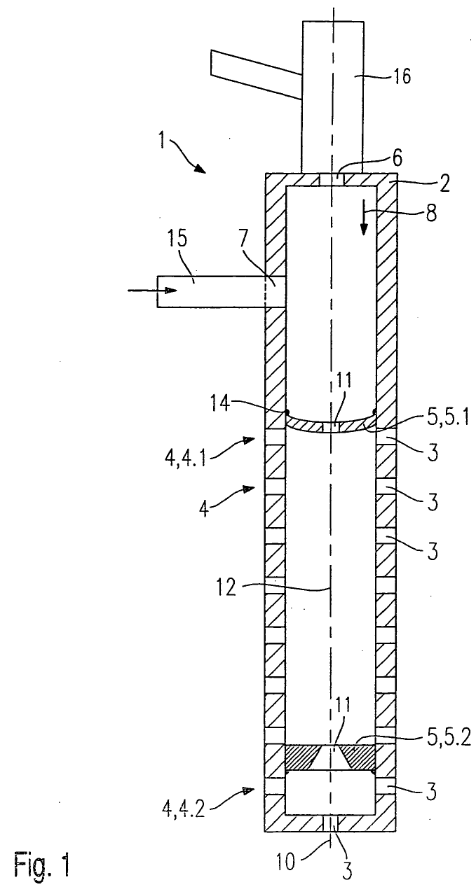

A first exemplary embodiment, schematically represented in FIG. 1, of an atomizer nozzle 1 according to the present invention is in the form of an atomizer nozzle 1 for the use of low-pressure fuel injectors 16. Atomizer nozzle 1 is particularly suitable for charging and atomizing fuel into a chemical reformer (not shown) for obtaining hydrogen.

In this exemplary embodiment, atomizer nozzle 1 features a nozzle body 2 in the shape of a hollow cylinder having a metering aperture 6 at the top centrally situated with respect to a center axis 10 of nozzle body 2. This is followed, in the direction of fuel flow 8, by a gas supply port 7 situated on the side wall of nozzle body 2, by eight elevation steps 4, each having a spray-discharge orifice 3 situated at a right angle to center axis 10 of nozzle body 2, and finally by the end wall of nozzle body 2 lying across from metering aperture 6 and having a spray-discharge orifice 3.

In front of the first elevation step 4.1 and in front of the last elevation step 4.2 in direction of fuel flow 8, nozzle body inserts 5 having flow-through openings 11 located at the center axis are situated in nozzle body 2. In this exemplary embodiment, the center axes 12 of flow-through openings 11 coincide with center axis 10 of nozzle body 2. Nozzle body inserts 5 are disk-shaped, the first nozzle body insert 5.1 situated upstream in front of first elevation step 4.1 being concavely retracted at the periphery against direction of fuel flow 8. At their periphery, nozzle body inserts 5 are sealingly joined to nozzle body 2 in such a way that no fuel or gas can penetrate between nozzle body 2 and the periphery of nozzle body insert 5. In this exemplary embodiment, nozzle body insert 5 and nozzle body 2 are joined by a laser-welded joint 14. They may also be pressed in. Spray-orifice disks, as known from fuel injectors, are singularly suited for use as nozzle body inserts 5.

Flow-through opening 11 of first nozzle body insert 5.1 has a rectangular bore cross-section, while that of last nozzle body insert 5.2 opens up downward in the shape of a trapezoid. Additional exemplary embodiments according to the present invention may have additional nozzle body inserts 5 positioned between elevation steps 4, while the shape of nozzle body inserts 4, their installation position, and the shape or the combination of shapes of flow-through openings 11 may be combined and varied as required for controlling fuel flow, gas flow and pressure conditions.

The fuel is metered via metering aperture 6, in this exemplary embodiment via a low-pressure fuel injector 16, into atomizer nozzle 1, i.e. nozzle body 2, and then flows in direction of fuel flow 8 along center axis 10 of nozzle body 2, past gas supply port 7, through which residual gases and/or air are fed into nozzle body 2 via a gas pipe 15, to first nozzle body insert 5.1. The fuel or the fuel/gas mixture then passes through flow-through opening 11, after which at least part of the fuel or fuel/gas mixture is discharged through spray-discharge orifices 3 located at the level of the relevant elevation steps 4 into a metering space (not shown). The remaining portion of the fuel or fuel/gas mixture passes through flow-through opening 11 of last nozzle body insert 5.2 opening downward in direction of fuel flow 8 in the shape of a trapezoid and is then able to escape nozzle body 2, i.e. atomizer nozzle 1, at comparatively low pressure through subsequent spray-discharge orifices 3 of last elevation step 4.2 and through spray-discharge orifice 3 located at the lower end of nozzle body 2 into the metering space (not shown).

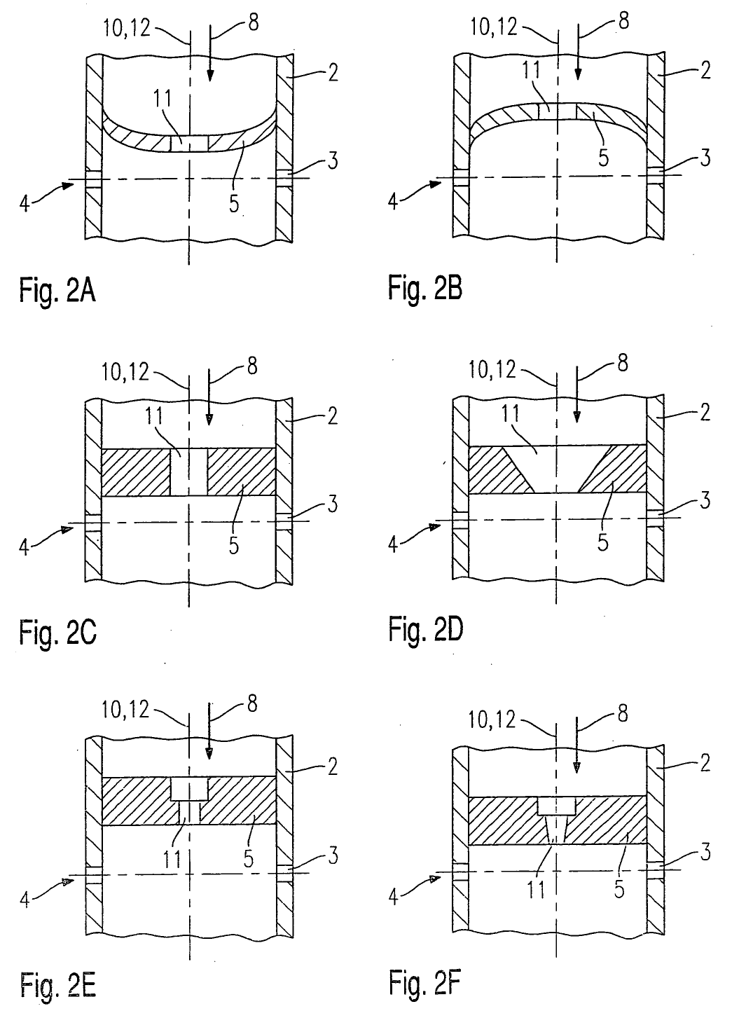

FIG. 2A shows a first specific embodiment of nozzle body insert 5 located in atomizer nozzle 1 of the present invention, disk-shaped nozzle body insert 5 being concavely retracted at the periphery against direction of fuel flow 8. Nozzle body insert 5 is pressed into nozzle body 2 and sits in direction of fuel flow 8 in front of elevation step 4 and corresponding spray-discharge orifices 3. Center axis 12 of flow-through opening 11 coincides with center axis 10 of nozzle body 2.

FIG. 2B shows a second specific embodiment of nozzle body insert 5 located in atomizer nozzle 1 of the present invention, disk-shaped nozzle body insert 5 being concavely retracted at the periphery with respect to direction of fuel flow 8. Nozzle body insert 5 is pressed into nozzle body 2 and sits in direction of fuel flow 8 in front of elevation step 4 and corresponding spray-discharge orifices 3. Center axis 12 of flow-through opening 11 coincides with center axis 10 of nozzle body 2.

FIG. 2C shows a third specific embodiment of nozzle body insert 5 located in atomizer nozzle 1 of the present invention. Centrally situated flow-through opening 11 is implemented as a stepless bore hole. Disk-shaped nozzle body insert 5 is pressed into nozzle body 2 and sits in direction of fuel flow 8 in front of elevation step 4 and corresponding spray-discharge orifices 3. Center axis 12 of flow-through opening 11 coincides with center axis 10 of nozzle body 2.

FIG. 2D shows a fourth specific embodiment of nozzle body insert 5 located in atomizer nozzle 1 of the present invention. Centrally situated flow-through opening 11 is trapezoidal in its longitudinal cross-section, narrowing in direction of fuel flow 8. Disk-shaped nozzle body insert 5 is pressed into nozzle body 2 and sits in direction of fuel flow 8 in front of elevation step 4 and corresponding spray-discharge orifices 3. Center axis 12 of flow-through opening 11 coincides with center axis 10 of nozzle body 2.

FIG. 2E shows a fifth specific embodiment of nozzle body insert 5 located in atomizer nozzle 1 of the present invention. Centrally situated flow-through opening 11 is implemented as a single-step stepped bore hole, the first partial bore in direction of fuel flow 8 having a larger diameter. Disk-shaped nozzle body insert 5 is pressed into nozzle body 2 and sits in direction of fuel flow 8 in front of elevation step 4 and corresponding spray-discharge orifices 3. Center axis 12 of flow-through opening 11 coincides with center axis 10 of nozzle body 2.

FIG. 2F shows a sixth specific embodiment of nozzle body insert 5 located in atomizer nozzle 1 of the present invention. Centrally situated flow-through opening 11 features two different geometrical shapes in its cross-section. The first geometrical shape in direction of fuel flow 8 is rectangular, while the subsequent shape is trapezoidal, narrowing in the downward direction. Disk-shaped nozzle body insert 5 is pressed into nozzle body 2 and sits in direction of fuel flow 8 in front of elevation step 4 and corresponding spray-discharge orifices 3. Center axis 12 of flow-through opening 11 coincides with center axis 10 of nozzle body 2.

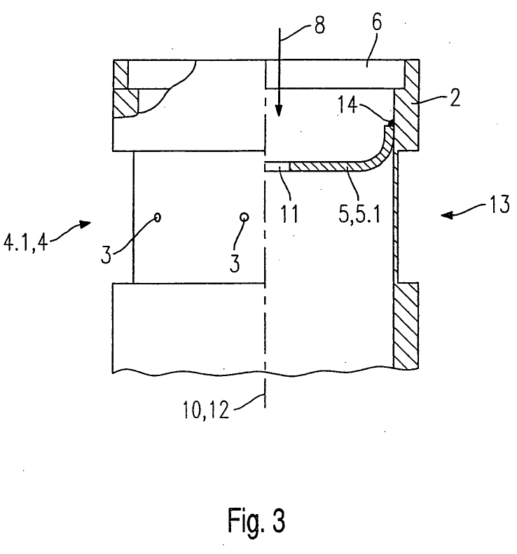

FIG. 3 shows an exemplary embodiment of atomizer nozzle 1 in the area of elevation step 4, nozzle body 2 in the area of elevation step 4 featuring a section 13 of reduced wall thickness which in this exemplary embodiment decreases the outer diameter of cylindrical nozzle body 2 along section 13. Section 13, which may, for example, also increase the inner diameter of nozzle body 2, may be repeatedly arranged in sequence in nozzle body 2 even at short intervals and it is not necessary that it run in the area of elevation step 4 or of spray-discharge orifices 3.

Disk-shaped nozzle body insert 5 is concavely retracted at the periphery against direction of fuel flow 8, is pressed into nozzle body 2 and sits in direction of fuel flow 8 in front of section 13 and of elevation step 4 and corresponding spray-discharge orifices 3. Center axis 12 of flow-through opening 11 coincides with center axis 10 of nozzle body 2. Metering aperture 6 situated at the upper end of nozzle body 2 is designed in this exemplary embodiment to receive a discharge-side end of a fuel injector (not shown).

The present invention is not limited to the exemplary embodiments described but is applicable to any other atomization systems.

1-13. (canceled)

14. An atomizer nozzle for a fuel, comprising:
a nozzle body including spray-discharge orifices for discharging into a metering space and including at least one metering aperture, wherein:
the spray-discharge orifices are situated, with a radial directional component with respect to a center axis of the nozzle body, at elevation steps, and
each elevation step includes at least one of the spray-discharge orifices; and
at least one nozzle body insert including at least one flow-through opening and being situated in the nozzle body at least one of in front of a first of the elevation steps in a direction of fuel flow and between the elevation steps.

15. The atomizer nozzle as recited in claim 14, wherein:
the atomizer nozzle is for charging a chemical reformer for obtaining hydrogen.

16. The atomizer nozzle as recited in claim 14, wherein:
the nozzle body includes a hollow cylinder.

17. The atomizer nozzle as recited in claim 14, wherein:
the nozzle body includes a gas supply port situated in the nozzle body between the first of the elevation steps in the direction of fuel flow and the at least one metering aperture.

18. The atomizer nozzle as recited in claim 14, wherein:
downstream of a last of the elevation steps in the direction of fuel flow, at least one additional spray-discharge orifice is situated with an axial directional component with respect to the center axis of the nozzle body.

19. The atomizer nozzle as recited in claim 14, wherein:
the at least one nozzle body insert is at least one of pressed and welded to the nozzle body in a hydraulically leak-proof manner.

20. The atomizer nozzle as recited in claim 14, wherein:
the at least one nozzle body insert is laser welded to the nozzle body in a hydraulically leak-proof manner.

21. The atomizer nozzle as recited in claim 14, wherein:
a center axis of the at least one flow-through opening of the at least one nozzle body insert runs parallel to the center axis of the nozzle body.

22. The atomizer nozzle as recited in claim 14, wherein:
the at least one nozzle body insert has a rectangular cross-section.

23. The atomizer nozzle as recited in claim 14, wherein:
the at least one nozzle body insert is concavely retracted from the at least one flow-through opening toward the nozzle body against the direction of fuel flow.

24. The atomizer nozzle as recited in claim 14, wherein:
the at least one nozzle body insert is concavely retracted from the at least one flow-through opening toward the nozzle body in the direction of fuel flow.

25. The atomizer nozzle as recited in claim 14, wherein:
a cross-section of the at least one flow-through opening is one of rectangular and trapezoidal.

26. The atomizer nozzle as recited in claim 14, wherein:
the at least one flow-through opening has at least two uniform cross-sections of different size.

27. The atomizer nozzle as recited in claim 14, wherein:
the at least one flow-through opening has at least two uniform cross-sections of different size corresponding to a stepped bore hole.

28. The atomizer nozzle as recited in claim 14, wherein:
the nozzle body includes at least one section of reduced wall thickness in an axial profile thereof.

29. The atomizer nozzle as recited in claim 28, wherein:
the at least one section of reduced wall thickness runs in an area of an elevation step.
